(19) United States
(12) Patent Application Publication
(10) Pub. No.: US 2006/0039300 A1
(43) Pub. Date: Feb. 23, 2006

(54) Method and apparatus for location discovery in mobile ad-hoc networks

(75) Inventors: Richard G. Ogier, Belmont, CA (US); Mark G. Lewis, Emerald Hills, CA (US)

Correspondence Address: MOSER, PATTERSON & SHERIDAN, LLP;SRI INTERNATIONAL, 595 SHREWSBURY AVENUE, SUITE 100, SHREWSBURY, NJ, 07702, US

(73) Assignee: SRI International

(21) Appl. No.: 11/210,510

(22) Filed: Aug. 23, 2005

Related U.S. Application Data
(60) Provisional application No. 60/604,140, filed on Aug. 23, 2004.

(51) Int. Cl. H04L 12/28

(52) U.S. Cl. 370/254

(57) ABSTRACT

A method and apparatus are provided for performing location discovery in mobile ad-hoc networks. In one embodiment, a method for estimating the location of a node in a network (comprising a plurality of nodes communicatively coupled by a plurality of links) includes receiving estimated distances for only a subset of the links and estimating the location of the node in accordance with the estimated distances.

### CROSS REFERENCE TO RELATED APPLICATIONS

This application claims the benefit of U.S. Provisional Patent Application Ser. No. 60/604,140, filed Aug. 23, 2004 (titled “Method for Location Discovery in Mobile Ad-Hoc Networks”), which is herein incorporated by reference in its entirety.

### FIELD OF THE INVENTION

The present invention relates generally to computer networks and relates more specifically to mobile ad-hoc networks.

### BACKGROUND OF THE DISCLOSURE

FIG. 1 is a schematic diagram illustrating an exemplary mobile ad-hoc network (MANET) 100. The network 100 comprises a plurality of mobile nodes (e.g., computing devices) 102l-102n (hereinafter collectively referred to as “nodes 102”) communicatively coupled via a plurality of links 104l-104n (hereinafter collectively referred to as “links 104”). The configuration of nodes 102 and links 104 defines the topology of the network 100. Specifically, at any given time, the topology of the network 100 can be described by the graph G=(V, E), where V is the set of nodes v and E is the set of directed links (u, v). A bidirectional link between node u and node v is represented by two directed links, (u, v) and (v, u). Because the nodes 102 are mobile, the topology of the network 100 is dynamic.

The estimation of a node's location in the network 100 may prove useful for a variety of applications, including location-aware applications, navigation, tracking and sensor networks, among others. However, only a subset of the nodes 102 (e.g., so-called “anchor nodes”, designated as A) typically know their locations at a given time. The problem of location discovery can be divided into two sub-problems: (1) ranging (e.g., estimating the distances of a node 102 to its neighbor nodes 102); and (2) position estimation (e.g., estimating a node's physical position given the estimated distances to anchor nodes).

Known methods for position estimation, while simple, tend to be inefficient because all estimated link distances are periodically sent to a single processing node, which then computes the estimated positions of the nodes. While such an approach may work well for a relatively small network, the amount of bandwidth consumed makes it impractical for use networks that contain a large number of links and nodes. These known methods are thus not easily scalable.

Thus, there is a need in the art for a method and apparatus for location discovery in mobile ad-hoc networks.

### SUMMARY OF THE INVENTION

A method and apparatus are provided for performing location discovery in mobile ad-hoc networks. In one embodiment, a method for estimating the location of a node in a network (comprising a plurality of nodes communicatively coupled by a plurality of links) includes receiving estimated distances for only a subset of the links and estimating the location of the node in accordance with the estimated distances.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating an exemplary mobile ad-hoc network 100;

FIG. 2 is a flow diagram illustrating one embodiment of a method for node location discovery, according to the present invention;

FIG. 3 is a flow diagram illustrating one embodiment of a method for computing a maximally disjoint path from a given node to an anchor node, according to the present invention;

FIG. 4 is a flow diagram illustrating one embodiment of a method for disseminating estimated link distances, according to the present invention; and

FIG. 5 is a high level block diagram of the present method for node location that is implemented using a general purpose computing device.

To facilitate understanding, identical reference numerals have been used, where possible, to designate identical elements that are common to the figures.

### DETAILED DESCRIPTION

The present invention relates to a method and apparatus for location discovery in mobile ad-hoc networks, e.g., multi-hop, mobile wireless networks in which only a small subset of the nodes contained therein known their positions. In one embodiment, the invention enables the efficient computation of node location in a network by disseminating estimated distances for only a relatively small subset of links in the network. This greatly improves the scalability of the computation by reducing the amount of bandwidth needed to disseminate topology changes, and therefore may be better-suited for large networks (e.g., comprising large numbers of nodes and links) than existing node location methods.

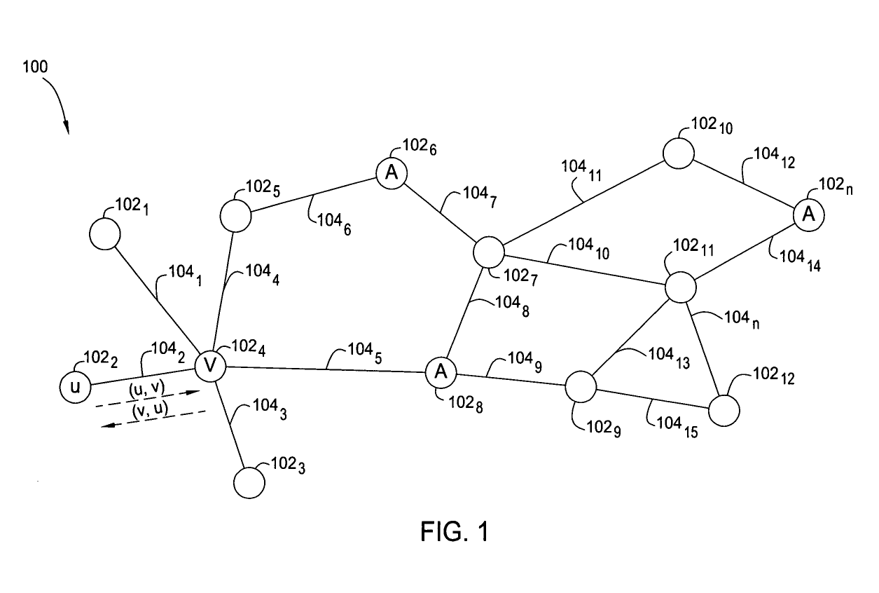

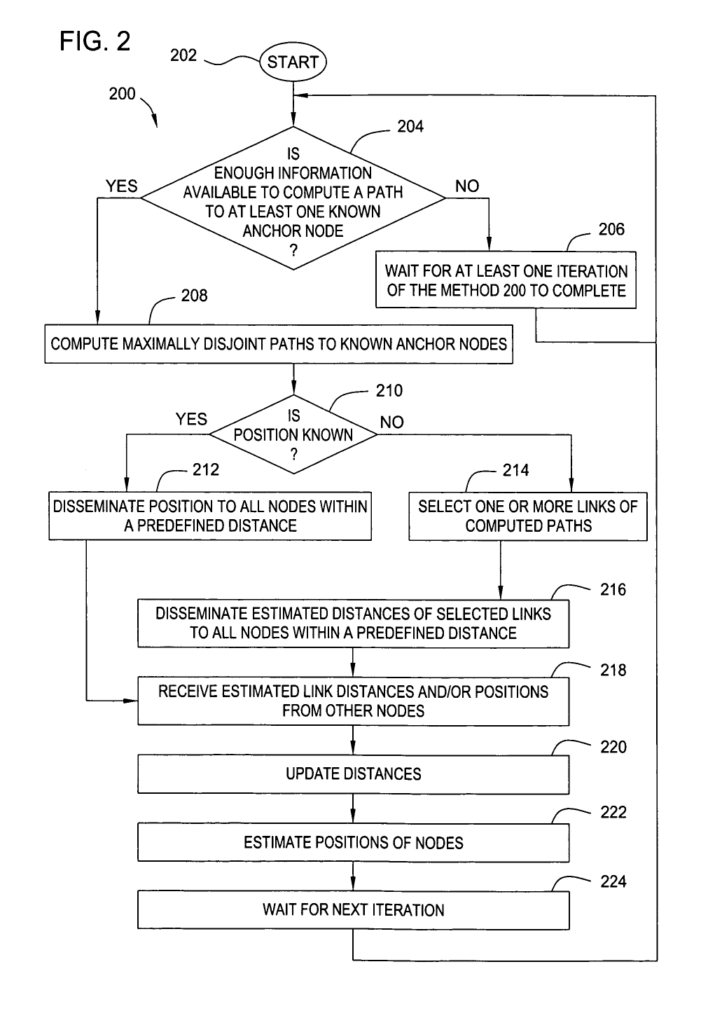

FIG. 2 is a flow diagram illustrating one embodiment of a method 200 for node location discovery, according to the present invention. The method 200 may be implemented, for example, at a node i in a network such as the MANET 100 of FIG. 1.

The method 200 is initialized at step 202 and proceeds to step 204, where the method 200 determines whether or not there is enough information available to compute a path to at least one known anchor node. As described above, anchor nodes are nodes that know their physical position within the network. In one embodiment (e.g., where the method 200 has only just begun to execute and has performed no or few complete iterations), only the neighbor nodes of the anchor nodes (e.g., nodes that are within one hop of the anchor nodes) will initially be able to compute paths to the anchor nodes in accordance with step 204. That is, upon the first several iterations of the method 200, there may not yet be enough information available at step 204 to compute the paths, depending on where the node i at which the method 200 is executing is relative to the anchor nodes.

If the method 200 determines in step 204 that there is not enough information available yet to compute a path to at least one anchor node, the method 200 proceeds to step 206 and waits for at least one iteration of the method 200 to complete. The method 200 then returns to step 204 and determines whether the completed iteration has now provided enough information to compute a path to at least one anchor node. Further iterations of the method 200, as described below, will enable nodes that are further away from the anchor nodes to compute the paths to the anchor nodes. For example, a second iteration of the method 200 will allow nodes within two hops of the anchor nodes to compute paths to the anchor nodes, based on link distances disseminated by the anchor nodes' neighbor nodes as described in further detail below.

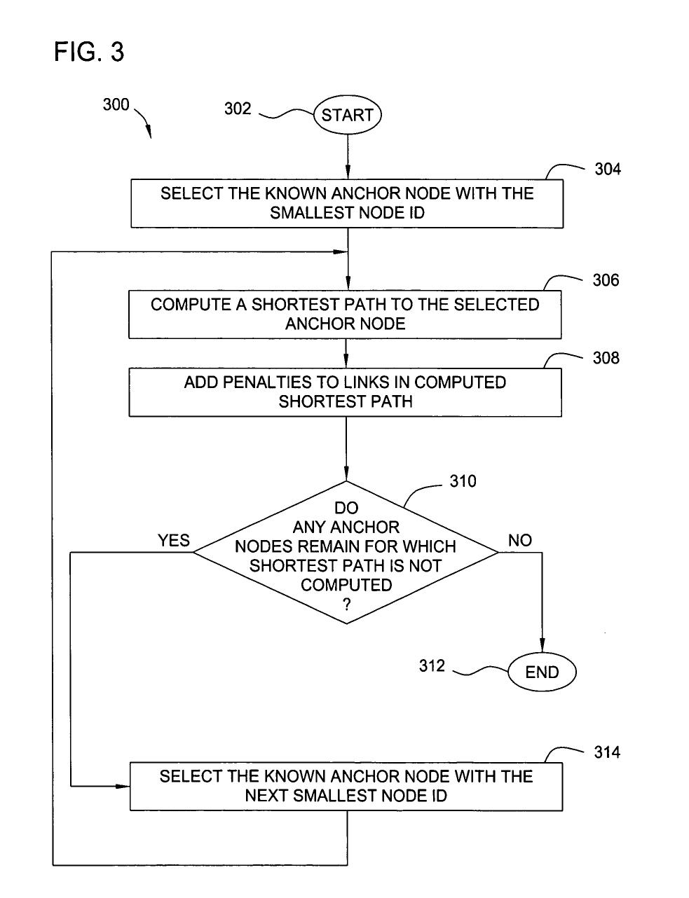

Alternatively, if the method 200 determines in step 204 that there is enough information available to compute a path to at least one anchor node, the method 200 proceeds to step 208 and computes the maximally disjoint paths to known anchor nodes. The maximally disjoint paths can utilize any links that are in the subset H(i) of links known by the node i at which the method 200 is executing, as well as any known links (i, j) to neighbor nodes j. In one embodiment, the subset H(i) comprises links to nodes that are within a predefined distance (e.g., K hops) of the node i. One embodiment of a method for computing the maximally disjoint paths is illustrated in FIG. 3.

In step 210, the method 200 determines whether the position of the node i at which the method 200 is executing is known (i.e., whether the node i is an anchor node). If the position of the node i is known, the method 200 proceeds to step 212 and disseminates the position of the node i to all nodes within a predefined distance of the node i (e.g., within K hops).

Alternatively, if the method 200 determines that the position of the node i is not known, the method 200 proceeds to step 214 and selects one or more links (i, j) of the computed maximally disjoint paths for dissemination to other nodes. In one embodiment, a subset H of links (u, v) in the computed paths is selected for dissemination. In one embodiment, this subset H comprises all links (u, v) in the computed disjoint paths to the anchor nodes. In another embodiment, the selected subset H comprises all non-leaf links (u, v) on the computed paths. A leaf link is a link (u, v) that is used by node u, and no other node, on a computed path to an anchor node. That is, in this embodiment, a link (u, v) on a computed path to an anchor node is disseminated only if there exists a node w that has selected node u to be the next node on its computed path to an anchor node. If no such node w exists, then the node u is a leaf node for the anchor node, and the link (u, v) is a leaf link for the anchor node. In such an embodiment, the estimated link distance D(i, j) is still reported to one-hop neighbors of the node i at which the method 200 is executing, but is not reported to all nodes within the predefined distance of the node i.

In step 216, the method 200 disseminates the estimated distances D(i, j) of the selected links. In one embodiment, the estimated distances D(i, j) are disseminated to all nodes within a predefined distance (e.g., K hops) of the node i at which the method 200 is executing.

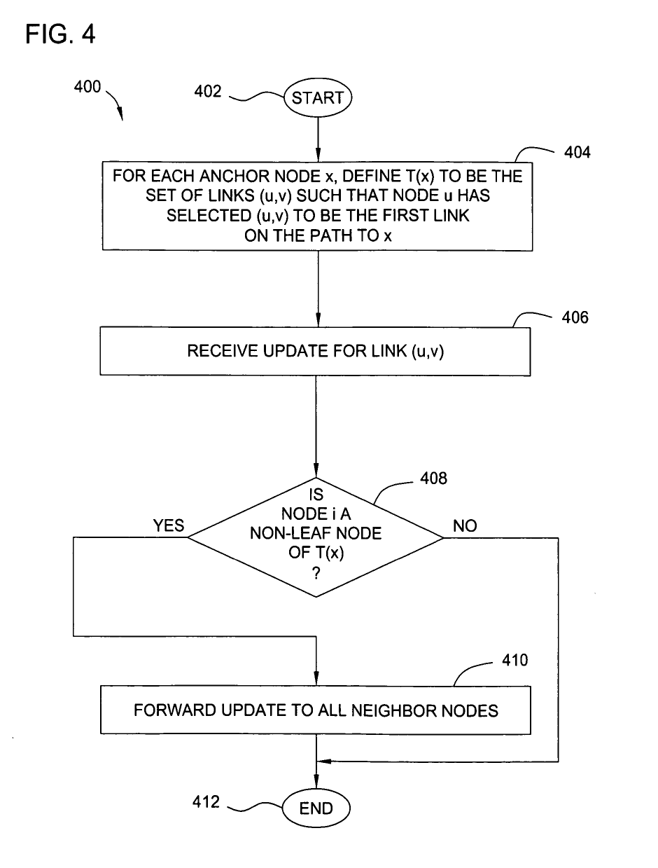

In one embodiment, dissemination of the node i's position or of the estimated distances D(i, j) of the selected links is performed in accordance with a classical full flooding protocol or with a more efficient flooding mechanism such as topology broadcast based on reverse-path forwarding (TBRPF) flooding or flooding based on a routing tree that is defined by the computed paths to the anchor nodes. One embodiment of a method for flooding based on such a routing tree is described in further detail with respect to FIG. 4.

In step 218, the method 200 receives estimated link distances and/or node positions disseminated by other nodes in the network. In one embodiment, the flooding mechanism implemented in step 216 substantially ensures that the node i at which the method 200 is executing will now know the estimated distances D(u, v) of all links (u, v) in the subset H that are within a predefined distance (e.g., K hops). In this case, H(i) denotes the subset of H that is known by the node i at which the method 200 is executing. Since there will only be a few anchor nodes within the predefined distance, H(i) should be much smaller that the set of all links (u, v) that are within the predefined distance.

In step 220, the method 200 updates the estimated distances, e.g., in a local database of the node i at which the method 200 is executing. That is, when an estimated distance D(u, v) for a link (u, v) is received in step 218, the method 200 updated this distance in step 220 to reflect the newly received information. In one embodiment, if no update has been received for a given link (u, v) within a certain period of time, the method 200 deletes the information for the link (u, v).

In step 222, the method 200 computes the estimated position of the node i at which the method 200 is executing, as well as the estimated positions of other nodes in the MANET, in accordance with the estimated link distances and known node positions (e.g., of the anchor nodes). In one embodiment, the estimated positions are computed by minimizing a sum-of-squared errors objective function, given the distances D(u, v) for all links (u, v) in the subset H(i) of links known to the node i, given the distances D(i, j) of the node i to each neighbor node j and given the known positions of the anchor nodes that are within a predefined distance (e.g., K hops) of the node i. The objective function to be minimized may be expressed as:

$$\begin{matrix}{\sum }_{( u , v ) ∈ {E}^{′}} {[ D ( u , v ) - dist ( u , v ) ]}^{2} where & ( EQN . 1 ) \\ dist ( u , v ) = \sqrt{{( x ( u ) - x ( v ) )}^{2} + {( y ( u ) - y ( v ) )}^{2}} & ( EQN . 2 )\end{matrix}$$

and x(u), y(u), x(v) and y(v) are estimated positions or coordinates of nodes u and v. E′ is a set of all links (u, v) for which the distance D(u, v) is know by node i (e.g., where the distances D(i, j) from node i to each neighbor node j, and the distances D(u, v) for each link (u, v) in H(i) are known). Although the objective function has been expressed in terms of a two-dimensional space, those skilled in the art will appreciate that the concept may be extended to the three-dimensional plane. In one embodiment, paths to at least three anchor nodes are needed in order to calculate an accurate estimate.

In step 224, the method 200 waits for the next iteration of the method 200 to start. In one embodiment, the iterations occur in static intervals (e.g., every x seconds). In another embodiment, the iterations occur in dynamic intervals based on how dynamic the network topology is or based on the occurrence of a significant change to the network topology. In one embodiment, a significant change is one that alters the configuration of paths to the anchor nodes or that involves a given distance difference from a previous position for a given number of nodes. For example, the time between iterations may be shortened if a significant number of nodes have changed position since the last iteration. Conversely, the time between iterations may be lengthened if no significant changes in node position have occurred since the last iteration. Once the next iteration starts, the method 200 returns to step 204 and proceeds as described above in order to re-estimate the positions of the mobile nodes within the MANET, e.g., as the nodes move freely about in the physical space.

The method 200 thereby enables the efficient computation of node location in a network by disseminating estimated distances for only a relatively small subset of links. This greatly improves the scalability of the computation by reducing the amount of bandwidth needed to disseminate topology changes, and therefore may be better-suited for large networks (e.g., comprising large numbers of nodes and links) than existing node location methods.

FIG. 3 is a flow diagram illustrating one embodiment of a method 300 for computing a maximally disjoint path from a given node to an anchor node, according to the present invention. The method 300 may be executed at, for example, a node i in accordance with step 208 of the method 200.

The method 300 is initialized at step 302 and proceeds to step 304, where the method 300 selects the known anchor node having the smallest node ID (e.g., lowest IP address or router ID). The form of the node ID will depend on the particular implementation of the network.

In step 306, the methods 300 computes a shortest path to the selected anchor node (assuming all links in the network have unit cost). In one embodiment, the shortest path is computed using a known method such as Dijkstra's algorithm.

In step 308, the method 300 adds penalties to the links of the computed shortest path. In one embodiment, a penalty assigned to a link is at least n times the unit link cost, where n is equal to the number of nodes in the network.

In step 310, the method 300 determines whether there are any remaining anchor nodes for which a shortest path has not been computed. If the method 300 determines in step 310 that there are no such anchor nodes remaining, the method 300 terminates in step 312.

Alternatively, if the method 300 determines in step 310 that there are anchor nodes remaining for which shortest paths have not been computed, the method 300 proceeds to step 314 and selects the known anchor node having the next smallest node ID. The method 300 then returns to step 306 and proceeds as described above in order to compute the shortest paths to the remaining anchor nodes.

FIG. 4 is a flow diagram illustrating one embodiment of a method 400 for disseminating estimated link distances, according to the present invention. The method 400 may be implemented, for example, at a node i in accordance with step 216 of the method 200.

The method 400 is initialized at step 402 and proceeds to step 404, where the method 400 defines, for each anchor node x, T(x), where T(x) is a set of links (u, v) such that node u has selected link (u, v) to be the first link on node u's path to the anchor node x. Thus, T(x) defines a tree that is rooted at node u and directed toward node x.

In step 406, the method 400 receives an update for the link (u, v) (e.g., an updated estimate of link (u, v)'s distance) for anchor node x, for example as indicated by a duplicate cache or an increased sequence number.

In step 408, the method 400 determines whether the node i at which the method 400 is executing is a non-leaf node of T(x). If the method 400 determines in step 408 that the node i is not a non-leaf node (e.g., is a leaf node), the method 400 terminates in step 412.

Alternatively, if method 400 determines in step 408 that the node i is a non-leaf node, the method 400 proceeds to step 410 and forwards the update to all neighbor nodes. The method 400 then terminates in step 412. In this manner, all nodes that are within a predefined distance (e.g., K hops) of the anchor node x will learn the distances D(u, v) for all non-leaf links of T(x) (e.g., for all links in the subset H that are on computed paths to an anchor node x).

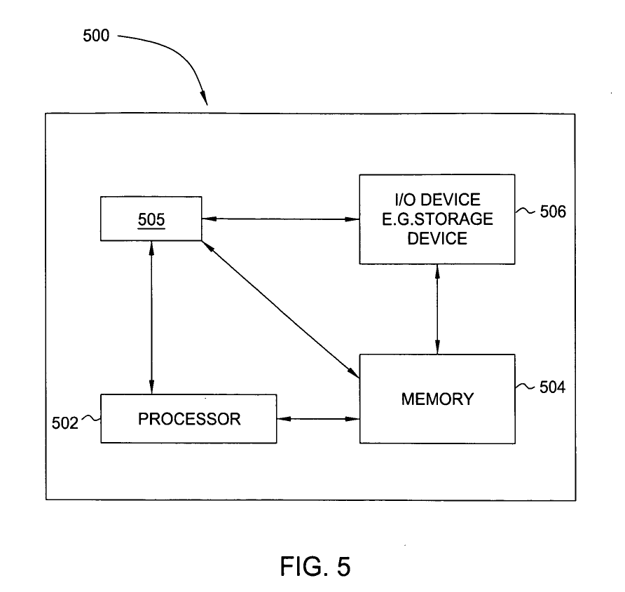

FIG. 5 is a high level block diagram of the present method for node location that is implemented using a general purpose computing device 500. In one embodiment, a general purpose computing device 500 comprises a processor 502, a memory 504, a node location module 505 and various input/output (I/O) devices 506 such as a display, a keyboard, a mouse, a modem, and the like. In one embodiment, at least one I/O device is a storage device (e.g., a disk drive, an optical disk drive, a floppy disk drive). It should be understood that the node location module 505 can be implemented as a physical device or subsystem that is coupled to a processor through a communication channel.

Alternatively, the node location module 505 can be represented by one or more software applications (or even a combination of software and hardware, e.g., using Application Specific Integrated Circuits (ASIC)), where the software is loaded from a storage medium (e.g., I/O devices 506) and operated by the processor 502 in the memory 504 of the general purpose computing device 500. Thus, in one embodiment, the node location module 505 for locating nodes in mobile ad-hoc networks described herein with reference to the preceding Figures can be stored on a computer readable medium or carrier (e.g., RAM, magnetic or optical drive or diskette, and the like).

Thus, the present invention represents a significant advancement in the field of computer networks. Embodiments of the enable the efficient computation of node location in a network by disseminating estimated distances for only a relatively small subset of links in the network. This greatly improves the scalability of the computation by reducing the amount of bandwidth needed to disseminate topology changes, and therefore may be better-suited for large networks than existing node location methods.

Although various embodiments which incorporate the teachings of the present invention have been shown and described in detail herein, those skilled in the art can readily devise many other varied embodiments that still incorporate these teachings.

What is claimed is:

1. A method for estimating a location of a node in a network comprising a plurality of nodes communicatively coupled by a plurality of links, comprising:
receiving estimated distances for only a subset of said plurality of links; and
estimating said location in accordance with said estimated distances.

2. The method of claim 1, wherein said subset comprises one or more links on a maximally disjoint path from at least one of said plurality of nodes to an anchor node.

3. The method of claim 2, wherein said one or more links comprises all non-leaf links.

4. The method of claim 2, wherein said one or more links coupled said node to one or more of said plurality of nodes that are within a predefined distance from said node.

5. The method of claim 4, wherein said predefined distance is measured as a number of hops.

6. The method of claim 1, wherein said subset comprises one or more links from said node to a neighbor node.

7. The method of claim 1, further comprising:
receiving a position of at least one anchor node in addition to said estimated distances.

8. The method of claim 1, wherein said estimating comprises:
updating estimated distances of said subset of said plurality of links, in accordance with said received estimated distances; and
minimizing an objective function in accordance with said updated estimated distances.

9. The method of claim 1, further comprising:
computing at least one maximally disjoint path to at least one anchor node; and
disseminating at least one link of said at least one maximally disjoint path to at least some of said plurality of nodes.

10. The method of claim 9, wherein said disseminating is performed in accordance with at least one of: a classical full-flooding protocol, a topology broadcast based on reverse-path forwarding protocol or a routing tree defined by said at least one maximally disjoint path.

11. The method of claim 9, wherein said at least one maximally disjoint path is utilizes at least one of: one or more links from said node to a neighbor node or one or more links that couple said node to a node within a predefined distance from said node.

12. The method of claim 9, wherein said at least some of said plurality of nodes comprise nodes within a predefined distance from said node.

13. The method of claim 12, wherein said predefined distance is measured as a number of hops.

14. The method of claim 1, further comprising:
estimating a location of at least one of said plurality of nodes.

15. A computer readable medium containing an executable program for estimating a location of a node in a network comprising a plurality of nodes communicatively coupled by a plurality of links, the method comprising:
receiving estimated distances for only a subset of said plurality of links; and
estimating said location in accordance with said estimated distances.

16. The computer readable medium of claim 15, wherein said subset comprises one or more links on a maximally disjoint path from at least one of said plurality of nodes to an anchor node.

17. The computer readable medium of claim 16, wherein said one or more links coupled said node to one or more of said plurality of nodes that are within a predefined distance from said node.

18. The computer readable medium of claim 15, wherein said estimating comprises:
updating estimated distances of said subset of said plurality of links, in accordance with said received estimate distances; and
minimizing an objective function in accordance with said updated estimated distances.

19. The computer readable medium of claim 15, further comprising:
computing at least one maximally disjoint path to at least one anchor node; and
disseminating at least one link of said at least one maximally disjoint path to at least some of said plurality of nodes.

20. Apparatus for estimating a location of a node in a network comprising a plurality of nodes communicatively coupled by a plurality of links, the apparatus comprising:
means for receiving estimated distances for only a subset of said plurality of links; and
means for estimating said location in accordance with said estimated distances.
